(19) United States
(12) Patent Application Publication
(10) Pub. No.: US 2026/0148901 A1
(43) Pub. Date: May 28, 2026

(54) MULTILAYER CERAMIC CAPACITOR AND METHOD FOR MANUFACTURING THE SAME

(71) Applicant: SAMSUNG ELECTRO-MECHANICS CO., LTD., Suwon-si (KR)

(72) Inventors: Yonghwa Lee, Suwon-si (KR); Seung Yong Lee, Suwon-si (KR); Junghyun An, Suwon-si (KR); Sang Jin Park, Suwon-si (KR); Jinbok Shin, Suwon-si (KR); Choongseop Jeon, Suwon-si (KR); Jungeun Noh, Suwon-si (KR); Seungmi Lee, Suwon-si (KR); Hyunsik Chae, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/087,020

(22) Filed: Mar. 21, 2025

(30) Foreign Application Priority Data
Nov. 25, 2024 (KR) 10-2024-0169580

(51) Int. Cl. H01G 4/30; H01G 4/12

(52) U.S. Cl. CPC H01G 4/30; H01G 4/1227

(57) ABSTRACT

A multilayer ceramic capacitor according to an embodiment of the present disclosure includes a capacitor body including a dielectric layer and an internal electrode layer, and an external electrode positioned on an outer side of the capacitor body, in which the dielectric layer includes glass having a secondary phase including Ga and Li.

### CROSS-REFERENCE TO RELATED APPLICATION

This application claims priority to and the benefit of Korean Patent Application No. 10-2024-0169580 filed in the Korean Intellectual Property Office on Nov. 25, 2024, the entire contents of which are incorporated herein by reference.

### BACKGROUND OF THE INVENTION

### (a) Field of the Invention

The present disclosure relates to a multilayer ceramic capacitor and a method for manufacturing the same.

### (b) Description of the Related Art

Electronic components using ceramic materials include capacitors, inductors, piezoelectric elements, varistors, or thermistors. Among such ceramic electronic components, a multilayer ceramic capacitor (MLCC) may be used in various electronic devices due to its small size, high capacitance, and easy mounting.

For example, the multilayer ceramic capacitor (MLCC) may be used for chip-type capacitors that are mounted in boards of various electronic products to charge or discharge electricity, including imaging devices such as liquid crystal displays (LCDs), plasma display panels (PDPs), and organic light-emitting diode (OLED) displays, computers, personal portable terminals, and smartphones.

Recently, as the multilayer ceramic capacitors are used in various fields such as IT and automotive electronics, ensuring characteristics under more severe temperature conditions is required.

### SUMMARY OF THE INVENTION

An aspect of the present disclosure provides a multilayer ceramic capacitor with improved reliability and stability.

Another aspect of the present disclosure provides a method for manufacturing a multilayer ceramic capacitor with improved reliability and stability. However, the problems to be solved by embodiments of the present disclosure are not limited to the above-described problems, and can be variously expanded within the scope of the technical spirit included in the present disclosure.

A multilayer ceramic capacitor according to an implementation includes a capacitor body including a dielectric layer and an internal electrode layer, and an external electrode positioned on an outer side of the capacitor body, in which the dielectric layer includes glass having a secondary phase including Ga and Li.

The secondary phase may include a compound form in which Ga and Li are combined.

The glass may further include at least one auxiliary element selected from the group consisting of Al, Mg and Si.

The secondary phase may include a form in which the auxiliary element is combined with Ga and Li.

A ratio (I_{Li}/I_{Ga}) of a signal intensity of Li to a signal intensity of Ga measured by performing transmission electron microscopy-energy dispersive X-ray spectroscopy (TEM-EDS) on the glass may be 0.1 to 3.

The dielectric layer may include a plurality of particles of the glass, and an average particle size of the plurality of particles may be 100 nm to 500 nm.

The dielectric layer may include a plurality of particles of the glass, and a maximum particle size of the plurality of particles may be less than 1 μm.

The secondary phase may be derived from a complex compound including Ga and Li.

The dielectric layer may further include a barium titanate-based primary component.

The glass may be provided as a secondary component of the dielectric layer.

A method for manufacturing a multilayer ceramic capacitor according to another implementation of the present invention includes mixing a secondary component including a complex compound including Ga and Li and a barium titanate-based primary component powder to manufacture a dielectric slurry. The method includes manufacturing a dielectric green sheet using the dielectric slurry, and forming a conductive paste layer on the dielectric green sheet. The method includes stacking the green sheet to manufacture a dielectric green sheet laminate. The method includes firing the dielectric green sheet laminate to manufacture a capacitor body including a dielectric layer and an internal electrode layer. The method includes forming an external electrode on the capacitor body. The dielectric layer includes glass having a secondary phase including Ga and Li.

The complex compound may include a liquid phase.

A molar ratio of Ga included in the complex compound may be 0.1 to 9 parts by mole with respect to 100 parts by mole of the barium titanate-based primary component powder.

A molar ratio (M_{Li}/M_{Ga}) of the number of moles of Li included in the complex compound to the number of moles of Ga included in the complex compound may be 1 to 3.

The secondary component may further include at least one selected from the group consisting of an Al-containing compound, a Mg-containing compound, and a Si-containing compound.

A multilayer ceramic capacitor according to still another implementation includes a capacitor body including a dielectric layer and an internal electrode layer, and an external electrode positioned on an outer side of the capacitor body, in which the dielectric layer includes glass including Ga and Li.

The glass may further include at least one auxiliary element selected from the group consisting of Al, Mg and Si.

A ratio (I_{Li}/I_{Ga}) of a signal intensity of Li to a signal intensity of Ga measured by performing transmission electron microscopy-energy dispersive X-ray spectroscopy (TEM-EDS) on the glass may be 0.1 to 3.

The dielectric layer may include a plurality of particles of the glass, and an average particle size of the plurality of particles may be 100 nm to 500 nm.

According to an embodiment of the present disclosure, the glass having a secondary phase in which Ga and Li are combined is included in the dielectric layer, so that volatilization of highly volatile Li can be suppressed. Accordingly, the density is improved while the firing temperature of the dielectric layer is reduced through Li, so that the capacitance characteristics, stability, and moisture resistance reliability of the multilayer ceramic capacitor can be improved together.

### BRIEF DESCRIPTION OF THE DRAWINGS

FIG. 1 is a perspective view conceptually showing a multilayer ceramic capacitor according to an embodiment.

FIG. 2 is a conceptual cross-sectional view of the multilayer ceramic capacitor taken along line I-I′ of FIG. 1.

FIG. 3 is a conceptual cross-sectional view of the multilayer ceramic capacitor taken along line II-II′ of FIG. 1.

FIG. 4 shows high angle annular dark field-scanning transmission electron microscope (HAADF-STEM) analysis image and mapping images of a cross-section of a dielectric sample according to an Example.

FIG. 5 shows transmission electron microscopy-electron energy loss spectroscopy (TEM-EELS) graphs for a cross-section of the dielectric sample according to the Example.

FIG. 6 shows a particle size distribution diagram of glass measured on a cross-section of the dielectric sample according to the Example.

FIG. 7 shows scanning electron microscopy (SEM) analysis images of a cross-section of the dielectric sample according to the Example.

FIG. 8 shows SEM analysis images of a cross-section of a dielectric sample according to Comparative Example.

FIG. 9 is a graph showing changes in density according to the firing temperature of the dielectric samples of the Example and Comparative Example.

FIG. 10 is a graph showing changes in permittivity according to the firing temperature of the dielectric samples of the Example and Comparative Example.

FIG. 11 is a graph showing changes in contents of Li, Ga, and Al, respectively, according to the firing temperature of the dielectric sample of the Example.

FIG. 12 is a graph showing changes in Li/Al atomic ratio and Li/Ga atomic ratio according to the firing temperature of the dielectric sample of the Example.

FIG. 13 is a conceptual schematic view for illustrating a helium (He) gas permeability measurement device for measuring a density of a dielectric.

FIG. 14 is a graph showing analysis results using the helium (He) gas permeability measurement device for the dielectric samples of the Example and Comparative Example.

FIG. 15 is a graph showing a moisture resistance reliability evaluation result of a multilayer ceramic capacitor according to the Example.

FIG. 16 is a graph showing a moisture resistance reliability evaluation result of a multilayer ceramic capacitor according to the Comparative Example.

### DETAILED DESCRIPTION OF THE EMBODIMENTS

In the following detailed description, only certain exemplary embodiments of the present invention have been shown and described, simply by way of illustration. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including (comprising)” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise (include)”, and variations such as “comprises (includes)” or “comprising (including)”, will be understood to imply the inclusion of stated elements but not the exclusion of any other elements.

Further, in the entire specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

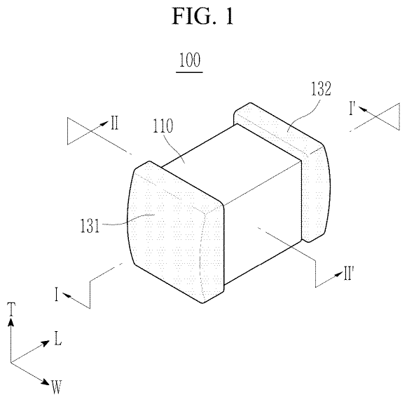

Below, a multilayer ceramic capacitor according to an embodiment of the present disclosure will be described with reference to FIGS. 1 to 3.

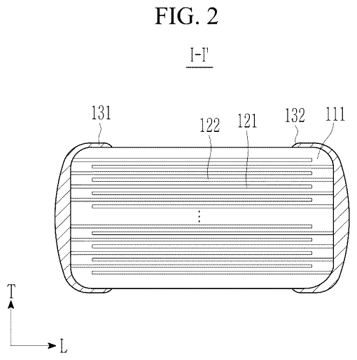

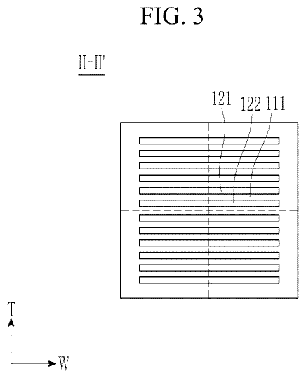

FIG. 1 is a perspective view conceptually showing a multilayer ceramic capacitor according to an embodiment. FIG. 2 is a conceptual cross-sectional view of the multilayer ceramic capacitor taken along line I-I′ of FIG. 1. FIG. 3 is a conceptual cross-sectional view of the multilayer ceramic capacitor taken along line II-II′ of FIG. 1.

Referring to FIGS. 1 to 3, a multilayer ceramic capacitor 100 may include a capacitor body 110 and external electrodes 131 and 132 arranged on an outer side of the capacitor body 110. The external electrodes 131 and 132 may include a first external electrode 131 and a second external electrode 132 arranged at both ends facing each other in the length direction (L-axis direction) of the capacitor body 110.

The L-axis, W-axis, and T-axis shown in FIGS. 1 to 3 represent the length direction, width direction, and thickness direction of the capacitor body 110, respectively. Here, the thickness direction (T-axis direction) may be a direction perpendicular to a wide surface (main surface) of sheet-shaped components, and may be used as the same concept as the stacking direction in which dielectric layers 111 are stacked, for example. The length direction (L-axis direction) may be a direction extending parallel to the wide surface (main surface) of the sheet-shaped components, may be approximately perpendicular to the thickness direction (T-axis direction), and may be, for example, a direction in which the first external electrode 131 and the second external electrode 132 are positioned on both sides. The width direction (W-axis direction) may be a direction extending parallel to the wide surface (main surface) of the sheet-shaped components and may be approximately perpendicular to both the thickness direction (T-axis direction) and the length direction (L-axis direction), and a length in the length direction (L-axis direction) of the sheet-shaped components may be greater than a length in the width direction (W-axis direction).

In an embodiment, the capacitor body 110 may have a substantially hexahedral shape.

Below, for convenience of description, both surfaces facing each other in the thickness direction (T-axis direction) of the capacitor body 110 are defined as a first surface and the second surface, both surfaces connected to the first surface and the second surface and facing each other in the length direction (L-axis direction) are defined as a third surface and a fourth surface, and both surfaces connected to the first surface and the second surface, connected to the third surface and the fourth surface, and facing each other in the width direction (W-axis direction) are defined as a fifth surface and a sixth surface.

The first surface, which is a lower surface of the capacitor body 110, may be a surface facing toward a mounting direction of the multilayer ceramic capacitor 100. At least one of the first to sixth surfaces may be flat. Alternatively, at least one of the first to sixth surfaces may be a curved surface with a convex central portion, and corners, which are boundaries of the respective surfaces, may be rounded.

The shape and dimensions of the capacitor body 110, and the number of dielectric layers 111 stacked are not limited to those shown in the drawings of the present disclosure.

The capacitor body 110 may include a dielectric layer 111 and internal electrode layers 121 and 122. The capacitor body 110 may include a plurality of dielectric layers 111.

The capacitor body 110 may include a plurality of dielectric layers 111, and first internal electrodes 121 and second internal electrodes 122 that are alternately arranged in the thickness direction (T-axis direction) with the dielectric layers 111 interposed therebetween.

The boundaries between adjacent dielectric layers 111 may be integrated to the extent that they are difficult to identify without using an SEM.

The capacitor body 110 may include an active region. The active region may be a portion that contributes to capacitance formation of the multilayer ceramic capacitor 100. For example, the active region may be a region where the first internal electrode 121 or the second internal electrode 122 stacked along the thickness direction (T-axis direction) overlaps.

The capacitor body 110 may further include a cover region and a side margin region.

The cover region is a margin portion in the thickness direction and may be positioned adjacent to the first surface and the second surface of the active region in the thickness direction (T-axis direction), respectively. For example, a single dielectric layer 111 or two or more dielectric layers 111 may be stacked on upper and lower surfaces of the active region, respectively, and provided as the cover region.

The side margin region is a margin portion in the width direction and may be positioned adjacent to the fifth surface and the sixth surface of the active region in the width direction (W-axis direction), respectively. The side margin region may be formed by stacking dielectric green sheets where a conductive paste layer is applied to only a portion of the surface of the dielectric green sheet and the conductive paste layer is not applied to both side sides of the surface of the dielectric green sheet, and then firing the sheets.

For example, the cover region and the side margin region can prevent damage to the first internal electrode 121 and the second internal electrode 122 from physical or chemical stress.

The dielectric layer 111 may include a barium titanate-based compound as a primary component. For example, by using the barium titanate-based compound as a dielectric matrix, the dielectric properties of the multilayer ceramic capacitor 100 can be ensured.

The barium titanate-based compound may include BaTiO₃, BaZrO₃, BaSnO₃, CaTiO₃, CaZrO₃, CaSnO₃, SrTiO₃, SrZrO₃, SrSnO₃, or the like. These may be used alone or in combination of two or more.

According to an embodiment, the dielectric layer 111 may include glass having a secondary phase including gallium (Ga) and lithium (Li). Since Ga and Li are not present individually in the dielectric layer 111 but are present in a secondary phase form in which Ga and Li are combined, volatilization of highly volatile Li can be suppressed. Accordingly, the density is improved while the firing temperature of the dielectric layer 111 is reduced through Li, so that the capacitance characteristics, stability, and moisture resistance reliability of the multilayer ceramic capacitor 100 can be improved together.

The glass may be provided as a secondary component of the dielectric layer 111.

The secondary component may include manganese (Mn), chromium (Cr), silicon (Si), aluminum (AI), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), or the like. These may be used alone or in combination of two or more.

The term “secondary phase” as used herein may refer to a new phase precipitated after sintering of the dielectric layer 111 or the capacitor body 110. For example, when a dielectric green sheet laminate including a barium titanate-based primary component and a secondary component (e.g., the glass) is fired, elements such as Ga and Li may be precipitated in the form of a secondary phase without being dissolved in the barium titanate lattice.

The secondary phase may include a compound form in which Ga and Li are combined. For example, a compound in which Ga and Li are chemically bonded may be provided as the secondary phase. Accordingly, Ga is combined with Li, thereby suppressing the volatilization of Li. Accordingly, the sintering temperature of the dielectric layer 111 can be reduced.

In an embodiment, the secondary phase may be derived from a complex compound including Ga and Li. The complex compound may be introduced in a liquid phase to form a liquid glass precursor, and the liquid glass precursor may be fired to form the glass.

According to an embodiment, the glass may further include at least one auxiliary element selected from the group consisting of Al, Mg and Si. The secondary phase may be formed as a result of the auxiliary element being combined with Ga and Li. For example, the secondary phase may include a form in which the auxiliary element is combined together with Ga and Li.

The presence of the secondary phase and the components included in the secondary phase may be confirmed through high angle annular dark field-scanning transmission electron microscopy (HAADF-STEM) analysis, energy dispersive X-ray spectroscopy (EDS) mapping analysis, and transmission electron microscopy-electron energy loss spectroscopy (TEM-EELS) analysis.

The multilayer ceramic capacitor 100 may be fixed with epoxy resin and polished with a polisher so that a cross-section (L-T cross-section) taken along the length direction (L-axis direction) and the stacking direction (T-axis direction) perpendicular to the width direction at the center in the width direction (W-axis direction) of the multilayer ceramic capacitor 100. The polishing may be performed to remove half of a length in the width direction (W-axis direction). A HAADF-STEM analysis image may be obtained for the dielectric layer 111 of the active region of the exposed L-T cross section. The HAADF-STEM analysis may be performed on a square region measuring 10 μm in width and 10 μm in height using a Tecnai Osiris 200 kV from FEI (USA). By performing an EDS mapping analysis on the acquired HAADF-STEM analysis image, mapping images may be acquired in which specific elements (e.g., Ga, Mg, Al, etc.) are marked to be visually distinguished. For a region where Ga is present in a mapping image, in which Ga is marked to be distinguished, of the mapping images, transmission electron microscope-electron energy loss spectroscopy (TEM-EELS) analysis may be performed. The TEM-EELS analysis may be performed on a square region measuring 10 μm in width and 10 μm in height using JEM-ARM200F (TEM) from JEOL and GIF Quantum (EELS) from Gatan. Through the TEM-EELS analysis, the presence or absence of Li within the region where Ga is present can be identified. Accordingly, the presence and composition of the glass having a secondary phase including Ga and Li can be confirmed.

A ratio (I_{Li}/I_{Ga}) of a signal intensity (I_{Li}) of Li to a signal intensity (I_{Ga}) of Ga measured by performing transmission electron microscopy-energy dispersive X-ray spectroscopy (TEM-EDS) on the glass may be 0.1 to 3. Within the range, Li combined with Ga remains sufficiently in the dielectric layer 111, so that the sintering temperature of the dielectric layer 111 can be further reduced and the density can be further improved.

According to an embodiment, the dielectric layer 111 may include a plurality of particles the above-described glass.

An average particle size of the particles may be in a range from 100 nm to 500 nm. Within the range, excessive agglomeration of particles can be suppressed, thereby further improving the low-temperature sintering characteristics and density of the dielectric layer 111. The average particle size may be an average of major axis lengths of the respective particles.

A maximum particle size of the particles may be less than 1 μm. Accordingly, the dispersibility of the particles can be further improved and the density can be further enhanced.

The particle size of the particles may be measured from the mapping image described above. For example, the active region of the L-T cross-section may be equally divided into three in the thickness direction, and the above-described mapping images may be obtained at three points (a total of nine points) in each of the upper, middle, and lower active regions. The major axis lengths of each of particles observed throughout the mapping images may be measured and averaged to determine the average particle size. The largest value among the major axis lengths of the particles observed in the mapping images may be evaluated as the maximum particle size.

According to an embodiment, an average thickness (average length in the T-axis direction) of the dielectric layer 111 may be about 1.0 μm to 8.0 μm. According to another embodiment, the average thickness (average length in the T-axis direction) of the dielectric layer 111 may be 2 μm to 6 μm. Within the above ranges, the reliability of the multilayer ceramic capacitor 100 can be further enhanced.

The average thickness of the dielectric layer 111 may be measured by performing SEM analysis on a cross-section (L-T cross-section) taken along the length direction (L-axis direction) and the stacking direction (T-axis direction) perpendicular to the width direction at the center in the width direction (W-axis direction) of the multilayer ceramic capacitor 100. The average thickness of the dielectric layer 111 may be obtained as an arithmetic mean of the thickness of the dielectric layer 111 measured at 10 points spaced apart at a predetermined interval from a central point as a reference point in the length direction (L-axis direction) or width direction (W-axis direction) of the dielectric layer 111 in the SEM analysis image. A spacing between the 10 points may be adjusted according to the scale of the scanning electron microscopy (SEM) image, and may be, for example, 1 μm to 100 μm, 1 μm to 50 μm, or 1 μm to 10 μm. In this case, all 10 points must be positioned within the dielectric layer 111, and if all 10 points are not positioned within the dielectric layer 111, the position of the reference point may be changed or the spacing between the 10 points may be adjusted.

The first internal electrode 121 and the second internal electrode 122 of the internal electrode layers 121 and 122 may have different polarities. For example, the first internal electrode 121 and the second internal electrode 122 may be alternately arranged to face each other along the T-axis direction with the dielectric layer 111 therebetween. For example, one end of the first internal electrode 121 may be exposed through the third surface of the capacitor body 110, and one end of the second internal electrode 122 may be exposed through the fourth surface of the capacitor body 110.

The first internal electrode 121 and the second internal electrode 122 can be electrically insulated by the dielectric layer 111 arranged therebetween.

An end portion of the first internal electrode 121 exposed through the third surface of the capacitor body 110 may be electrically connected to the first external electrode 131. For example, an end portion of the second internal electrode 122 exposed through the fourth surface of the capacitor body 110 may be electrically connected to the second external electrode 132.

The first internal electrode 121 and the second internal electrode 122 may each include conductive metal. For example, the conductive metal may include metal such as Ni, Cu, Ag, Pd, Au, Al, or Zr, or an alloy thereof (e.g., an Ag—Pd alloy).

The first internal electrode 121 and the second internal electrode 122 may include dielectric particles having the same composition as the ceramic material included in the dielectric layer 111.

The first internal electrode 121 and the second internal electrode 122 may be formed using a conductive paste including a conductive metal. A printing method of the conductive paste may include a screen printing method or a gravure printing method.

An average thickness of the first internal electrode 121 and the second internal electrode 122 may be 0.1 μm to 2 μm. The average thickness of the first internal electrode 121 and the second internal electrode 122 may be measured by scanning electron microscope (SEM) analysis. Here, the scanning electron microscope (SEM) analysis is the same as the method used to measure the average thickness of the dielectric layer 111 described above, so its description is omitted.

The capacitor body 110 may be formed by firing a laminate in which a plurality of dielectric layers 111 and internal electrode layers 121 and 122 are stacked.

Referring to FIG. 2, the first external electrode 131 and the second external electrode 132 may have different polarities.

Referring to FIG. 2, the first external electrode 131 and the second external electrode 132 may have different polarities. For example, the second external electrode 132 may be electrically connected by being joined to the exposed portion of the second internal electrode 122.

When a predetermined voltage is applied to the first external electrode 131 and the second external electrode 132, charges can be accumulated between the first internal electrode 121 and the second internal electrode 122 facing each other. The electrostatic capacitance of the multilayer ceramic capacitor 100 may be proportional to the overlapping area on the plane of the first internal electrode 121 and the second internal electrode 122 that overlap each other in the stacking direction (T-axis direction) in the active region.

The first external electrode 131 and the second external electrode 132 may include first and second connecting portions (not shown) respectively arranged on the third surface and the fourth surface of the capacitor body 110 and respectively connected to the first internal electrode 121 and the second internal electrode 122. The first external electrode 131 and the second external electrode 132 may include first and second band portions (not shown) arranged at corners, where the third and fourth surfaces, the first and second surfaces, or the fifth and sixth surfaces of the capacitor body 110 meet, respectively.

The first and second band portions may extend from the first and second connection portions to portions of the first and second surfaces or the fifth and sixth surfaces of the capacitor body 110, respectively. The adhesion strength of the first external electrode 131 and the second external electrode 132 can be improved through the first and second band portions.

The first external electrode 131 and the second external electrode 132 may each include a sintered metal layer in contact with the capacitor body 110, a conductive resin layer arranged to cover the sintered metal layer, and a plating layer arranged to cover the conductive resin layer.

The sintered metal layer may include a conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, copper (Cu) may include a copper (Cu) alloy. When the conductive metal includes copper, a metal other than copper may be included in an amount of 5 parts by mole or less with respect to 100 parts by mole of copper.

The glass may include a composition in which oxides are mixed and, for example, may include at least one selected from the group consisting of silicon oxide, boron oxide, aluminum oxide, transition metal oxide, alkali metal oxide, and alkaline earth metal oxide.

The transition metal may include at least one selected from the group consisting of zinc (Zn), titanium (Ti), copper (Cu), vanadium (V), manganese (Mn), iron (Fe), and nickel (Ni). The alkali metal may include at least one selected from the group consisting of lithium (Li), sodium (Na), and potassium (K). The alkaline earth metal may include at least one selected from the group consisting of magnesium (Mg), calcium (Ca), strontium (Sr), and barium (Ba).

Optionally, the conductive resin layer is formed on the sintered metal layer, and may be formed, for example, in a form that entirely covers the sintered metal layer. In an embodiment, the first external electrode 131 and the second external electrode 132 may not include the sintered metal layer. In this case, the conductive resin layer may be in direct contact with the capacitor body 110.

The conductive resin layer may extend to the first and second surfaces or the fifth and sixth surfaces of the capacitor body 110, and a length of a region (i.e., the band portion) in which the conductive resin layer extends to the first and second surfaces or the fifth and sixth surfaces of the capacitor body 110 and is arranged may be greater than a length of a region (i.e., the band portion) in which the sintered metal layer extends to the first and second surfaces or the fifth and sixth surfaces of the capacitor body 110 and is arranged. In an embodiment, the conductive resin layer may be formed on the sintered metal layer and entirely cover the sintered metal layer.

The conductive resin layer includes a resin and a conductive metal.

The resin included in the conductive resin layer is not particularly limited as long as it has adhesion and shock absorption properties and can be mixed with conductive metal powder to make a paste, and may include, for example, phenol resin, acrylic resin, silicone resin, epoxy resin, or polyimide resin.

The conductive metal included in the conductive resin layer may have a spherical shape, a flake shape, or a combination thereof. For example, the conductive metal may have only a flake shape or only a spherical shape, or may be in a mixed form of flake and spherical shapes.

Here, the spherical shape may also include a shape that is not a perfect sphere, for example, a shape having a length ratio of a major axis to a minor axis (major axis/minor axis) of 1.45 or less. Flake-shaped powder refers to a powder having a flat and elongated shape, and is not particularly limited, but for example, the length ratio of the major axis to the minor axis (major axis/minor axis) may be 1.95 or greater.

The first external electrode 131 and the second external electrode 132 may each further include a plating layer arranged on an outer side of the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb) alone or as an alloy thereof. For example, the plating layer may be a nickel (Ni) plating layer or a tin (Sn) plating layer, and may be in a form in which a nickel (Ni) plating layer and a tin (Sn) plating layer are sequentially stacked, or may be in a form in which a tin (Sn) plating layer, a nickel (Ni) plating layer, and a tin (Sn) plating layer are sequentially stacked. Additionally, the plating layer may include a plurality of nickel (Ni) plating layers and/or a plurality of tin (Sn) plating layers.

Through the plating layer, mountability on a substrate, structural reliability, durability against external impact and heat resistance of the multilayer ceramic capacitor 100 can be further improved, and equivalent series resistance (ESR) can be further reduced.

Below, a method for manufacturing the multilayer ceramic capacitor 100 according to an embodiment will be described.

A method for manufacturing a multilayer ceramic capacitor 100 may include steps of manufacturing a capacitor body 110 including a dielectric layer 111 and internal electrodes 121 and 122, and forming external electrodes 131 and 132 on an outer side of the capacitor body 110.

In an embodiment, a barium titanate (BaTiO₃)-based primary powder and a secondary component including a complex compound including Ga and Li may be mixed and heat-treated to obtain a calcined powder. An organic vehicle or an aqueous vehicle may be added to the calcined powder, which may be then heated and mixed to prepare a dielectric slurry.

The barium titanate-based primary component powder is a compound including barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr) O₃, (Ba, Ca)(Ti, Sn)O₃, (Ba, Sr)TiO₃, (Ba, Sr)(Ti, Zr)O₃, (Ba, Sr)(Ti, Sn)O₃, or combination thereof.

The complex compound may include a liquid phase. As an example, the complex compound can be provided as a Ga—Li liquid glass precursor including Ga and Li. Accordingly, the volatilization of Li due to sintering can be suppressed, and the dispersibility of the glass having a secondary phase including Ga and Li in the dielectric layer 111 can be further improved.

The complex compound may further include a ligand such as an organic substance, and in this case Ga and Li may be provided as complex ions. The organic substance and/or ligand may be selected without limitation as long as they are combined with Ga and Li.

According to an embodiment, a molar ratio of Ga included in the complex compound may be 0.1 to 9 parts by mole with respect to 100 parts by mole of the barium titanate-based primary component powder. Within the range, Ga can be combined with Li, thereby further suppressing the volatilization of Li. Accordingly, the density and glass dispersibility of the dielectric layer 111 can be further improved.

A molar ratio (M_{Li}/M_{Ga}) of the number of moles of Li included in the complex compound to the number of moles of Ga included in the complex compound may be 1 to 3. Within the range, the secondary phase including Ga and Li can be sufficiently formed, thereby further suppressing the volatilization of Li. Accordingly, the density and permittivity of the dielectric layer 111 can be further increased and the porosity can be further reduced.

The contents of the barium titanate-based primary component powder, Ga and Li included in the complex compound, and the like may be measured using inductively coupled plasma-optical emission spectroscopy (ICP-OES). For example, the contents of the barium titanate-based primary component powder, Ga and Li included in the complex compound, and the like may be measured using an Avio 500 device from PerkinElmer.

The secondary component may further include at least one selected from the group consisting of an Al-containing compound, a Mg-containing compound, and a Si-containing compound. The Al-containing compound, the Mg-containing compound, and the Si-containing compound may each be an oxide, nitride or salt compound, or may be used in the form of a sol dispersed in an organic solvent.

The dielectric slurry may be manufactured by additionally mixing additives such as a dispersant, a binder, a plasticizer, a lubricant, and an antistatic agent, and a solvent.

The dispersant may include a phosphoric acid ester-based dispersant, a polycarboxylic acid-based dispersant, or a combination thereof. The dispersant may be mixed in an amount of 0.1 to 5 parts by weight, for example, 0.3 to 3 parts by weight with respect to 100 parts by weight of the barium titanate-based compound. When the dispersant is mixed within the content range, the dispersibility of the dielectric slurry can be further improved, and an amount of impurities included in the manufactured dielectric layer can be reduced.

The binder may include acrylic resin, polyvinyl butyl resin, polyvinyl acetal resin, ethyl cellulose resin, and the like. The binder may be added in an amount of 0.1 to 50 parts by weight, for example, 3 to 30 parts by weight with respect to 100 parts by weight of the barium titanate-based compound. When the binder is mixed within the content range, the dispersibility of the dielectric slurry can be further improved, and the amount of impurities included in the manufactured dielectric layer can be further reduced.

The plasticizer may include a phthalate-based compound such as dioctyl phthalate, benzyl butyl phthalate, dibutyl phthalate, dihexyl phthalate, di(2-ethylhexyl) phthalate, and di(2-ethylbutyl) phthalate; an adipate-based compound such as dihexyl adipate and di(2-ethylhexyl) adipate; a glycol-based compound such as ethylene glycol, diethylene glycol, and triethylene glycol; and a glycol ester-based compound such as triethylene glycol dibutyrate, triethylene glycol di(2-ethylbutyrate), and triethylene glycol di(2-ethylhexanoate). The plasticizer may be added in an amount of 0.1 to 20 parts by weight, for example, 1 to 10 parts by weight with respect to 100 parts by weight of the barium titanate-based compound. When the plasticizer is mixed within the content range, the dispersibility of the dielectric slurry can be further improved, and an amount of impurities included in the manufactured dielectric layer can be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butyl carbitol acetate; an ether-based solvent such as methyl cellosolve, ethyl cellosolve, butyl ether, and tetrahydrofuran; an aromatic solvent such as benzene, toluene, and xylene, or the like. The solvent may include an alcohol-based solvent or an aromatic solvent, for example, taking into consideration the solubility or dispersibility of various additives included in the dielectric slurry. The solvent may be mixed in an amount of 50 to 1000 parts by weight, for example, 100 to 500 parts by weight with respect to 100 parts by weight of the barium titanate-based compound. When the solvent is mixed within the content range, the components of the dielectric slurry can be sufficiently mixed, and the solvent can then be easily removed.

The mixing of the dielectric slurry may be performed using a wet ball mill or a stirring mill. When zirconia balls are used in a wet ball mill, the wet mixing may be performed for 8 to 48 hours, or 10 to 24 hours using a plurality of zirconia balls with a diameter of 0.1 mm to 10 mm.

The manufactured dielectric slurry is formed into a dielectric layer 111 after firing.

A method for forming the manufactured dielectric slurry into a sheet shape may include a tape forming method such as a doctor blade method or a calendar roll method, and for example, an on-roll forming coater of a head discharge method may be used. Then, the shaped body may be dried to obtain a dielectric green sheet.

To form a conductive paste layer that will become internal electrode layers 121 and 122 after firing, a conductive powder made of a conductive metal or its alloy, a binder, and a solvent may be mixed to manufacture a conductive paste. Additionally, barium titanate powder may be mixed together as a co-material, as needed. The co-material can suppress sintering of the conductive powder during the sintering process. A conductive paste layer may be formed by applying the conductive paste in a predetermined pattern on a surface of the dielectric green sheet using various printing methods such as screen printing or a transfer method.

The conductive powder may include nickel (Ni) or a nickel (Ni) alloy.

Next, multiple layers of dielectric green sheets having internal electrode patterns formed thereon may be stacked and then pressed in a stacking direction to obtain a dielectric green sheet laminate. The dielectric green sheets and the internal electrode layer patterns may be stacked such that the dielectric green sheets are positioned on the upper and lower surfaces of the dielectric green sheet laminate in the stacking direction.

Optionally, the manufactured dielectric green sheet laminate may be cut into a predetermined size by dicing or the like.

The dielectric green sheet laminate may be solidified and dried to remove plasticizers and the like, as needed, and may be subjected to barrel polishing using a horizontal centrifugal barrel machine or the like after solidified and dried. In the barrel polishing, the dielectric green sheet laminate may be put into a barrel container together with a medium and a polishing liquid, and the barrel container may be applied with rotational motion or vibration, resulting in polishing of unnecessary parts such as burrs generated during cutting. After barrel polishing, the dielectric green sheet laminate may be washed with a cleaning solution such as water and dried.

The dielectric green sheet laminate may be subjected to binder removing and firing treatments to obtain a capacitor body 110.

The conditions for the binder removing treatment may be appropriately adjusted depending on the main component composition of the dielectric layer or the main component composition of the internal electrode. For example, a temperature increase rate during the binder removing treatment may be 5° C./hour to 300° C./hour, a support temperature may be 180° C. to 400° C., and a temperature holding time may be 0.5 hour to 24 hours. The binder removing atmosphere may be air or a reducing atmosphere.

The conditions for the sintering treatment may be appropriately adjusted depending on the primary component composition of the dielectric layer or the primary component composition of the internal electrode. For example, the temperature during firing may be 1200° C. to 1350° C., or 1220° C. to 1300° C., and the time may be 0.5 hour to 8 hours, or 1 hour to 3 hours. The firing atmosphere may be a reducing atmosphere, for example, a humidified atmosphere of a mixed gas of nitrogen gas (N₂) and hydrogen gas (H₂). When the internal electrodes 121 and 122 include nickel (Ni) or a nickel (Ni) alloy, an oxygen partial pressure in the firing atmosphere may be 1.0×10⁻¹⁴ MPa to 1.0×10⁻¹⁰ MPa.

After the firing treatment, annealing may be performed as needed. The annealing is a treatment for re-oxidizing the dielectric layer, and annealing may be performed when the firing treatment is performed in a reducing atmosphere. The conditions for annealing treatment may also be appropriately adjusted depending on the primary component composition of the dielectric layer and the like. For example, the temperature during annealing may be 950° C. to 1150° C., the time may be 0 hour to 20 hours, and the temperature increase rate may be 50° C./hour to 500° C./hour. The annealing atmosphere may be a humidified nitrogen gas (N₂) atmosphere, and the oxygen partial pressure may be 1.0×10⁻⁹ MPa to 1.0×10⁻⁵ MPa.

In the binder removing treatment, the firing treatment, or the annealing treatment, for example, a wetter may be used to humidify a nitrogen gas or a mixed gas, and in this case, the water temperature may be 5° C. to 75° C. The binder removing treatment, the firing treatment, and the annealing treatment may be performed consecutively or independently.

Optionally, a surface treatment such as sandblasting, laser irradiation, or barrel polishing may be performed on the third and fourth surfaces of the obtained capacitor body 110. Through such a surface treatment, the end portions of the first internal electrode 121 and the second internal electrode 122 can be exposed on the outermost surfaces of the third and fourth surfaces. Accordingly, the electrical connection between the first external electrode 131 and the second external electrode 132 and the first internal electrode 121 and the second internal electrode 122 is improved, and an alloy portion can be easily formed.

External electrodes 131 and 132 may be formed on one surface of the manufactured capacitor body 110.

For example, a paste for forming a sintered metal layer may be applied and then sintered to form a sintered metal layer.

The paste for forming a sintered metal layer may include the conductive metal and glass described above. Additionally, the paste for forming a sintered metal layer may optionally include a binder, a solvent, a dispersant, a plasticizer, and oxide powder, or the like. The binder may include, for example, ethyl cellulose, acrylic, butyral, or the like, and the solvent may include, for example, an organic solvent such as terpineol, butyl carbitol, alcohol, methyl ethyl ketone, acetone, or toluene, or an aqueous solvent.

As a method for applying the paste for forming a sintered metal layer to the outer surface of the capacitor body 110, a dip method, various printing methods such as a screen printing, an applying method using, for example, a dispenser, a spraying method using a spray, or the like may be used.

The paste for forming a sintered metal layer is applied to at least the third surface and the fourth surface of the capacitor body 110, and optionally may also be applied to a portion of the first surface, the second surface, the fifth surface, or the sixth surface where the band portions of the first external electrode and the second external electrode are formed.

Thereafter, the capacitor body 110 to which the paste for forming a sintered metal layer has been applied is dried and sintered at a temperature of 700° C. to 1000° C. for 0.1 to 3 hours, so that the sintered metal layer may be formed.

Optionally, a paste for forming a conductive resin layer may be applied to the outer surface of the obtained capacitor body 110 and then cured to form a conductive resin layer.

The paste for forming a conductive resin layer may include a resin and optionally a conductive metal or a non-conductive filler. The description of the conductive metal and resin is the same as the above description, so a redundant description will be omitted. Additionally, the paste for forming a conductive resin layer may optionally include a binder, a solvent, a dispersant, a plasticizer, an oxide powder, or the like. For the binder, for example, ethyl cellulose, acrylic, butyral, or the like may be used, and the solvent may include, for example, an organic solvent such as terpineol, butyl carbitol, alcohol, methyl ethyl ketone, acetone, or toluene, or an aqueous solvent.

For example, the conductive resin layer may be formed by dipping the capacitor body 110 in a paste for forming a conductive resin layer and then curing it, printing a paste for forming a conductive resin layer on a surface of the capacitor body 110 using a screen printing method, a gravure printing method, or the like, or applying a paste for forming a conductive resin layer on a surface of the capacitor body 110 and then curing it.

A plating layer may be formed on an outer side of the conductive resin layer.

For example, the plating layer may be formed by a plating method, a sputtering method, or an electric deposition method.

Specific examples of the present disclosure will be presented below. However, the examples described below are merely intended to provide specific examples or explanations.

### EXAMPLE

### (Preparation of Dielectric Sample)

100 parts by mole of barium titanate (BaTiO₃) primary component powder, and as secondary components, Ga—Li liquid complex compound, MgCO₃, Al₂O₃, and SiO₂ were added to an ethanol solvent in amounts of 2.2 parts by mole, 0.467 part by mole, 0.12 part by mole, and 1.38 parts by mole with respect to 100 parts by mole of barium titanate, respectively, and mixed to prepare a dielectric slurry. Specifically, 12 kg of barium titanate and about 500 g of the above-described secondary components were mixed with 40 kg of the ethanol solvent to prepare a dielectric slurry.

In the Ga—Li liquid complex compound, the ratio of the number of moles of Li to the number of moles of Ga was adjusted to 1:3.

The mixing was performed by using a zirconia ball (ZrO₂ ball) as a dispersion medium, adding ethanol/toluene, and polyvinyl butyral (PVB) resin as a wetting dispersant and binder, and then performing mechanical milling.

The prepared dielectric slurry was formed into a dielectric green sheet by using an on-roll forming coater of a head discharge method.

The dielectric green sheets were stacked and pressed to prepare a dielectric green sheet laminate.

The dielectric green sheet laminate was cut to a predetermined size and fired at 1075° C. to prepare a dielectric sample.

### (Preparation of Multilayer Ceramic Capacitor)

A dielectric green sheet was prepared as described above for the dielectric sample.

A conductive paste layer containing Ni was printed on a surface of the dielectric green sheet, and the dielectric green sheets with the conductive paste layer formed thereon were stacked and pressed to prepare a dielectric green sheet laminate.

The dielectric green sheet laminate was calcined at 400° C. or lower in a nitrogen atmosphere, and then maintained for 51 seconds and fired under conditions of a firing temperature of 1210° C. and a hydrogen concentration of 0.11%.

Then, the laminate was subjected to processes such as external electrode formation and plating, resulting in preparation of a multilayer ceramic capacitor.

### Comparative Example

100 parts by mole of barium titanate (BaTiO₃) primary component powder, and as secondary components, MgCO₃, Al₂O₃, and SiO₂ were added to an ethanol solvent in amounts of 0.467 part by mole, 0.12 part by mole, and 1.38 parts by mole with respect to 100 parts by mole of barium titanate, respectively, and mixed to prepare a dielectric slurry.

A dielectric sample and a multilayer ceramic capacitor were prepared in the same manner as in the Example, except that the prepared dielectric slurry was used.

### Evaluation 1: HAADF-STEM, EDS Mapping, and TEM-EELS Analysis

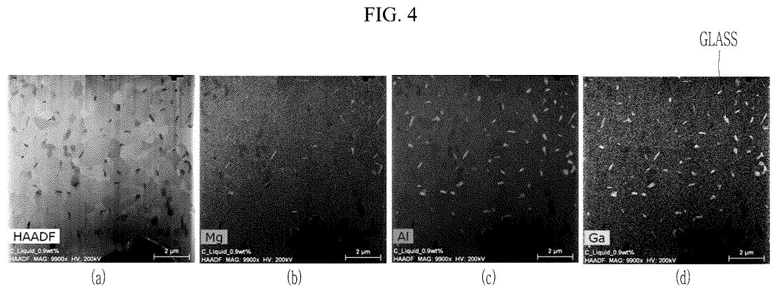

FIG. 4 is an HAADF-STEM analysis image ((a) of FIG. 4) and mapping images ((b), (c), and (d) of FIG. 4) of a cross-section of the dielectric sample according to the Example.

Referring to FIG. 4, a HAADF-STEM analysis image was obtained for a cross-section (L-T cross-section) taken along the length direction and the stacking direction perpendicular to the width direction at the center in the width direction of the dielectric samples prepared according to the Example and Comparative Example ((a) of FIG. 4). The HAADF-STEM analysis was performed on a square region measuring 10 μm in width and 10 μm in height using a Tecnai Osiris 200 kV from FEI (USA).

The EDS mapping analysis was performed on the acquired HAADF-STEM analysis image to obtain mapping images in which the glass particles including Mg, Al, and Ga were marked to be visually distinguished ((b), (c), and (d) of FIG. 4).

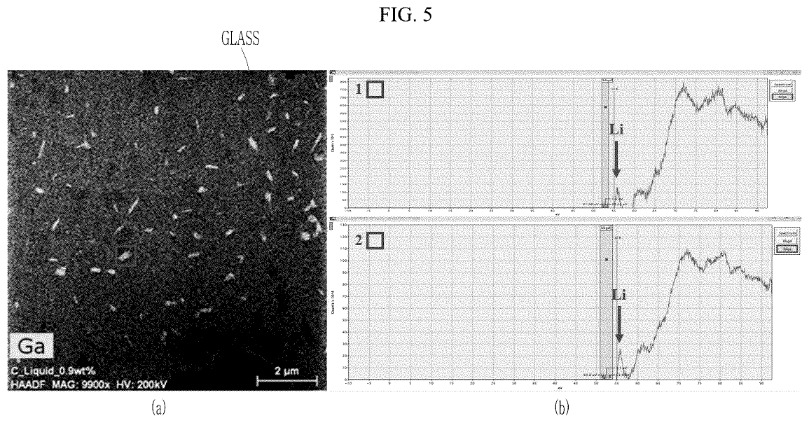

FIG. 5 shows TEM-EELS graphs for the L-T cross-section of the dielectric sample according to the Example. (a) of FIG. 5 is a mapping image in which glass particles containing Ga are marked, similar to (d) in FIG. 4. (b) of FIG. 5 is TEM-EELS analysis graphs of the first and second square regions of (a) of FIG. 5. The TEM-EELS analysis was performed on a region measuring 10 μm in width and 10 μm in height using JEM-ARM200F (TEM) from JEOL and GIF Quantum (EELS) from Gatan.

Referring to FIG. 5, a Li peak was observed within the secondary phase region where Ga is present through the TEM-EELS analysis, confirming the presence of glass having a secondary phase including Ga and Li.

The TEM-EDS analysis was performed on the first and second square regions of (a) of FIG. 5 to measure the peak intensities of elements included in each region. The measurement results are shown in Table 1 below. In Table 1, the peak intensity of the element measured in the first square region is expressed as “E1”, and the peak intensity of the element measured in the second square region is expressed as “E2.”

In Table 1, the peak intensity of each element in the first square region is divided by the peak intensity of Ga, which is expressed as “1/Ga”, and the peak intensity of each element in the second square region is divided by the peak intensity of Ga, which is expressed as “2/Ga.”

TABLE 1

| | O | Mg | Al | Si | Ga | Li |
|---|---|---|---|---|---|---|
| E1 | 61.1 | 4.1 | 1.9 | 8.8 | 2.2 | 1.0 |
| E2 | 60.6 | 2.6 | 1.7 | 12 | 2.9 | 1.4 |
| 1/Ga | 27.77 | 1.86 | 0.86 | 4.00 | 1.00 | 0.45 |
| 2/Ga | 20.90 | 0.90 | 0.59 | 4.14 | 1.00 | 0.48 |

Referring to Table 1, the ratio (I_{Li}/I_{Ga}) of the signal intensity of Li to the signal intensity of Ga in the first and second square regions of (a) of FIG. 5 was measured to be 0.45 and 0.48, respectively.

### Evaluation 2: Measurements of Average Particle Size and Maximum Particle Size of Glass

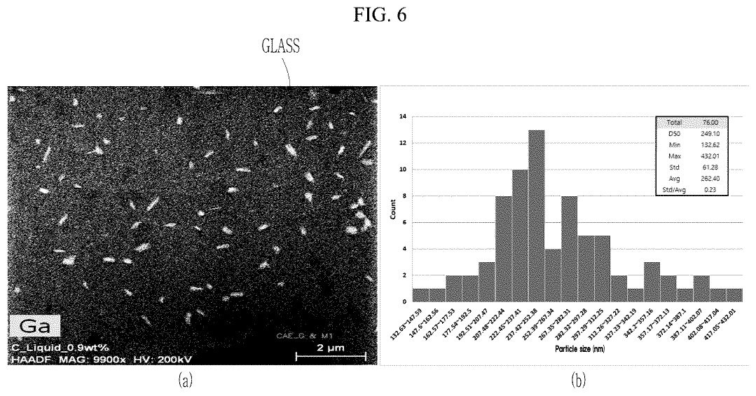

FIG. 6 shows a particle size distribution diagram of glass measured on the L-T cross-section of the dielectric sample according to the Example. (a) of FIG. 6 is a mapping image in which glass particles containing Ga are marked, similar to (d) in FIG. 4. (b) of FIG. 6 is a particle size distribution diagram of particles observed in (a) of FIG. 6.

Referring to FIG. 6, the major axis lengths (particle sizes) of the respective particles observed in the mapping image of the cross-section of the dielectric sample prepared according to the Example were measured and represented as a particle size distribution diagram.

The average of the particle sizes was evaluated as the average particle size. In the Example, the average particle size (“Avg” in FIG. 6) was measured to be 262.4 nm, which is relatively small. Additionally, the maximum particle size of the glass particles in the Example (“Max” in FIG. 6) was measured to be about 432.01 nm. Therefore, the formation of glass agglomerates with a particle size of 1 μm or greater was sufficiently suppressed.

### Evaluation 3: Porosity Measurement of Dielectric Samples

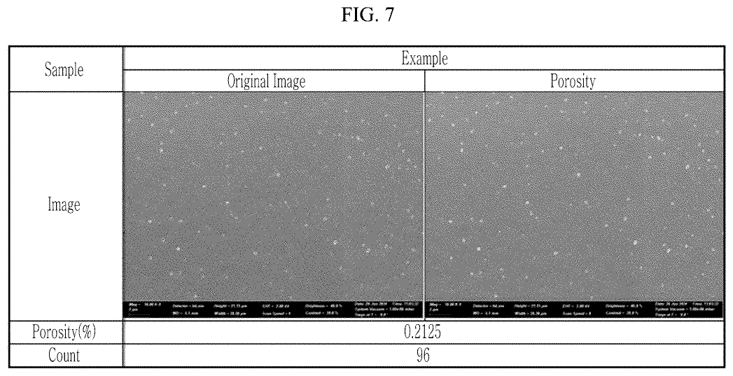

FIG. 7 shows SEM analysis images of the L-T cross-section of the dielectric sample according to the Example.

The SEM analysis may be performed on a region measuring approximately 30 μm in width and 30 μm in height using GeminiSEM 300 (Electron gun type) from Zeiss.

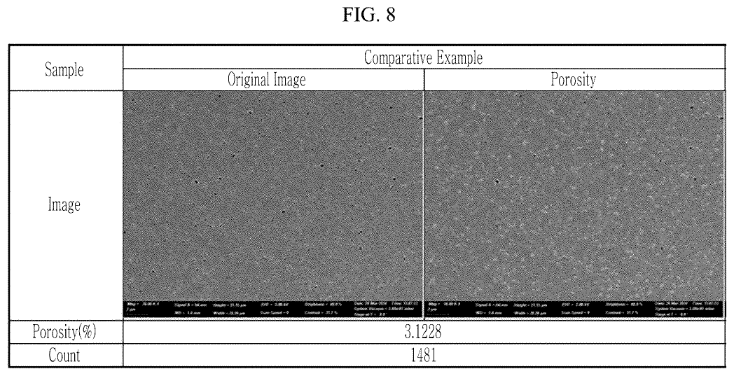

Referring to FIGS. 7 and 8, the SEM analysis images were obtained for the L-T cross sections of the dielectric samples prepared according to the Example and Comparative Example, respectively, and the number of pores and porosity were measured from the SEM analysis images.

The number of pores in the SEM analysis image of the Example was measured to be 96, and the porosity was measured to be 0.2125. The number of pores in the SEM analysis image of the Comparative Example was measured to be 1481, and the porosity was measured to be 3.1228.

Referring to FIGS. 7 and 8, in the Example including the glass having a secondary phase including Ga and Li, the number of pores and the porosity were relatively reduced compared to the Comparative Example. Accordingly, the density of the dielectric sample of the Example was improved compared to the density of the dielectric sample of the Comparative Example.

The number of pores and porosity of the Example and Comparative Example were measured using MiDAS (Microstructure image Database and Analysis System) 2.3.

### Evaluation 4: Density and Permittivity Measurement of Dielectric Samples

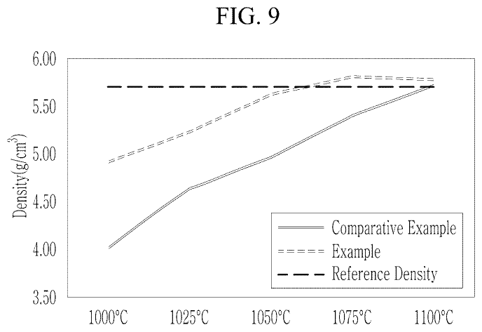

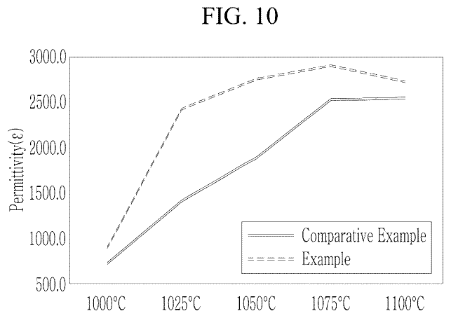

FIG. 9 is a graph showing changes in density according to the sintering temperature of the dielectric samples according to the Example and Comparative Example. FIG. 10 is a graph showing changes in permittivity according to the sintering temperature of the dielectric samples according to the Example and Comparative Example.

The density and permittivity of the dielectric samples of the Example and Comparative Example were measured while changing the sintering temperature from 1000° C. to 1100° C.

The volume was calculated by measuring the lengths in the length direction, the width direction, and the thickness direction of the dielectric sample, respectively, and the weight of the dielectric sample was measured, so that the density was calculated. The permittivity was measured according to ASTM D150-98.

Referring to FIGS. 9 and 10, the dielectric sample of the Example was measured to have the relatively higher density and permittivity at lower temperatures, compared to the dielectric sample of the Comparative Example. Therefore, the density and capacitance characteristics of the dielectric sample of the Example were relatively improved compared to the Comparative Example.

### Evaluation 5: Component Analysis of Dielectric Samples According to Firing Temperature

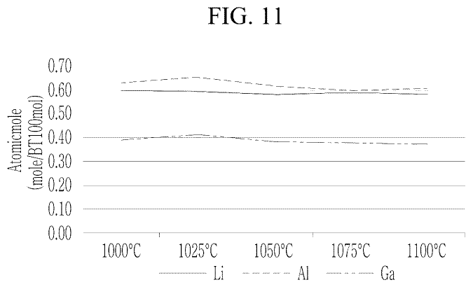

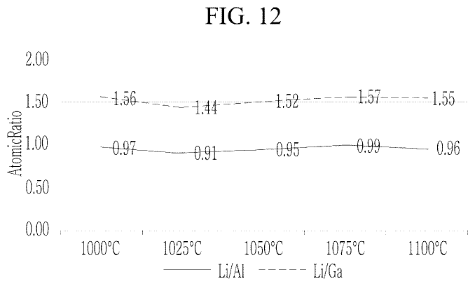

FIG. 11 is a graph showing changes in contents of Li, Ga, and Al, respectively, according to the firing temperature of the dielectric sample of the Example. FIG. 12 is a graph showing changes in Li/Al atomic ratio and Li/Ga atomic ratio according to the firing temperature of the dielectric sample of the Example.

While varying the firing temperature of the dielectric sample of the Example from 1000° C. to 1100° C., the contents (parts by mole) of Li, Al, and Ga elements with respect to 100 parts by mole of the barium titanate primary component powder were measured, and the results are shown in FIG. 11. The molar ratio of Li to Al and the molar ratio of Li to Ga are shown in FIG. 12.

The content of each element was measured using inductively coupled plasma-mass spectrometry (ICP-MS). Specifically, the content of each element was measured according to the firing temperature of the dielectric sample using NexION 300S from PerkinElmer.

### Evaluation 6: Volatilization Rate Analysis of Ga and Li

When preparing the dielectric sample, the molar ratio of Ga and Li in the Ga—Li liquid complex compound was adjusted as shown in Table 2, and the dielectric samples according to the reference examples were prepared by performing firing at the same temperature as in the Example.

The residual amounts of Li and Ga in the dielectric samples after firing were measured using the NexION 300S from PerkinElmer, and the volatilization rates according to firing were calculated. The residual amount represents the parts by mole of Li and Ga with respect to 100 parts by mole of the barium titanate (BT) primary component powder after firing.

The volatilization rate was calculated by dividing the difference between the input amount and the residual amount by the input amount and multiplying by 100.

In Table 2, the input amounts of Li and Ga represent the parts by mole of Li and Ga with respect to 100 parts by mole of the barium titanate (BT) primary component powder. In Table 2, “-” indicates a trace amount that is not detectable.

TABLE 2

| | Input amount | | | Residual amount | | Volatilization | |
|---|---|---|---|---|---|---|---|
| | (mol/BT100 mol) | | Molar ratio | (mol/BT100 mol) | | rate (%) | |
| | Li | Ga | (M_{Li}/M_{Ga}) | Li | Ga | Li | Ga |
| Reference | 9 | 9 | 1 | 8.91 | 8.74 | 1.0 | 2.9 |
| Example 1 | | | | | | | |
| Reference | 9 | 6 | 1.5 | 8.84 | 5.94 | 1.8 | 1.0 |
| Example 2 | | | | | | | |
| Reference | 9 | 3 | 3 | 8.94 | 2.98 | 0.7 | 0.7 |
| Example 3 | | | | | | | |
| (Example 1) | | | | | | | |
| Reference | 9 | 0.9 | 10 | 2.63 | 0.89 | 70.8 | 1.1 |
| Example 4 | | | | | | | |
| Reference | 9 | 0.6 | 15 | 1.72 | 0.58 | 80.9 | 3.3 |
| Example 5 | | | | | | | |
| Reference | 9 | 0.3 | 30 | 0.81 | 0.27 | 91.0 | 10.0 |
| Example 6 | | | | | | | |
| Reference | 9 | 0.09 | 100 | 0.242 | — | 97.3 | — |
| Example 7 | | | | | | | |
| Reference | 9 | 0.06 | 150 | 0.1 | — | 98.9 | — |
| Example 8 | | | | | | | |
| Reference | 9 | 0.03 | 300 | — | — | — | — |
| Example 9 | | | | | | | |

Referring to Table 2, in Reference Examples 7 to 9 where the input amount of Ga was less than 0.1 part by mole with respect to 100 parts by mole of the barium titanate primary component powder, Li and Ga were substantially completely volatilized.

In Reference Examples 1 to 3 where the molar ratio (M_{Li}/M_{Ga}) of the input amount of Li to the input amount of Ga was 1 to 3, the volatilization of Li was relatively suppressed compared to Reference Examples 4 to 9. Accordingly, the particle size of the glass is reduced and the dispersibility can be thus improved.

### Evaluation 7: Density Analysis of Dielectric Samples

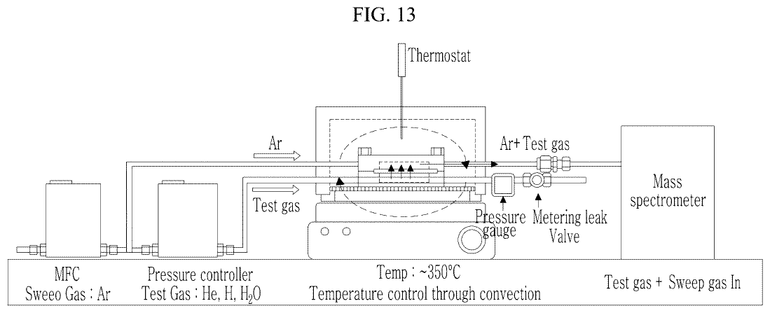

The dielectric samples prepared according to the Example and Comparative Example were placed into a helium (He) gas permeability measurement device (Agilent GC/MS, 5977B), and the pressure of helium (He) gas permeating the dielectric samples was measured. FIG. 13 is a conceptual schematic diagram illustrating a helium (He) gas permeability measurement device for measuring the density of a dielectric sample.

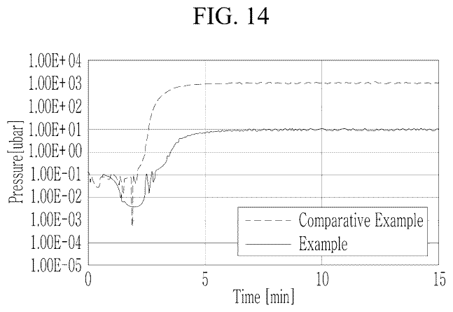

FIG. 14 is a graph showing analysis results using the helium (He) gas permeability measurement device for the dielectric samples of the Example and Comparative Example.

Referring to FIG. 14, since the density of the dielectric sample of the Example is relatively higher than that of the dielectric sample of the Comparative Example, the pressure of the permeating helium (He) gas was measured to be lower in the Example than in the Comparative Example.

### Evaluation 8: Characteristics Analysis of Multilayer Ceramic Capacitors (Cp, DF and BDV Analysis)

For the multilayer ceramic capacitors prepared according to the Example and Comparative Example, the electrostatic capacitance (Cp), the dissipation factor (DF), and the breakdown voltage (BDV) were measured.

Specifically, the electrostatic capacitance and the dissipation factor were measured using a capacitance meter (model number: 4268A) from Agilent. The breakdown voltage was measured using a high resistance/low current potentiometer (model number: 6430) from Keithley.

### (Moisture Resistance Reliability Analysis)

The moisture resistance reliability was evaluated for the multilayer ceramic capacitors prepared according to the Example and Comparative Example by measuring the changes in internal resistance (IR) for 12 hours under the conditions of 85° C., 85% relative humidity, and 15.75 V using ESPEC PR-3J 8585 equipment.

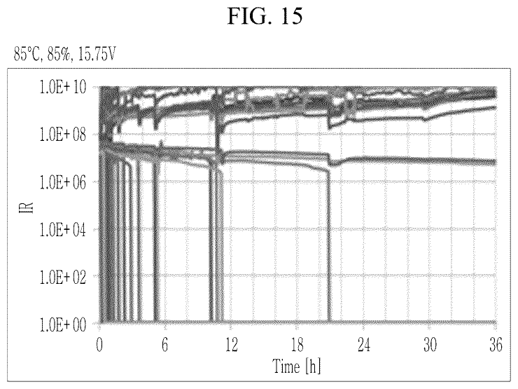

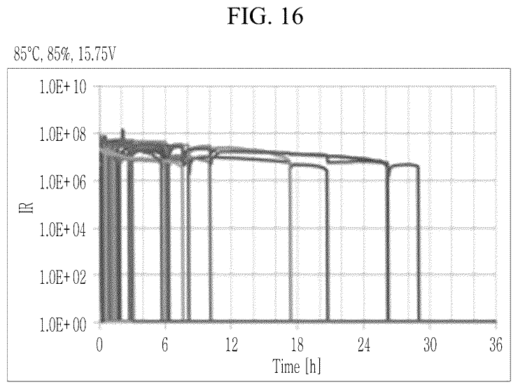

FIG. 15 is a graph showing a moisture resistance reliability evaluation result of a multilayer ceramic capacitor according to the Example. FIG. 16 is a graph showing a moisture resistance reliability evaluation result of a multilayer ceramic capacitor according to the Comparative Example.

Referring to FIGS. 15 and 16, in the Example, the IR remained relatively stable over time compared to that in the Comparative Example. Therefore, in the Example, the moisture resistance reliability was improved compared to the Comparative Example.

The measurement results are shown in Table 3 below. The failure rate in Table 3 represents a ratio of multilayer ceramic capacitors that failed (IR could not be maintained) when the moisture-resistant reliability evaluation was performed on multiple multilayer ceramic capacitors.

TABLE 3

| | Cp (μF) | DF (%) | BDV (V) | Failure rate (%) |
|---|---|---|---|---|
| Example | 2.22 | 1.5 | 41.3 | 55 |
| Comparative Example | 2.15 | 1.6 | 39.1 | 100 |

Referring to Table 3, in the Example including glass having a secondary phase including Ga and Li, the capacitance characteristics, low resistance characteristics, breakdown voltage, and driving reliability were relatively increased compared to those of the Comparative Example.

### DESCRIPTION OF SYMBOLS

100: multilayer ceramic capacitor
110: capacitor body
111: dielectric layer
121: first internal electrode
122: second internal electrode
131: first external electrode
132: second external electrode

What is claimed is:

1. A multilayer ceramic capacitor comprising:
a capacitor body comprising a dielectric layer and an internal electrode layer; and
an external electrode positioned on an outer side of the capacitor body, wherein
the dielectric layer comprises glass having a secondary phase including Ga and Li.

2. The multilayer ceramic capacitor of claim 1, wherein:
the secondary phase comprises a compound form in which Ga and Li are combined.

3. The multilayer ceramic capacitor of claim 1, wherein:
the glass further comprises at least one auxiliary element selected from the group consisting of Al, Mg and Si.

4. The multilayer ceramic capacitor of claim 3, wherein:
the secondary phase comprises a form in which the auxiliary element is combined together with Ga and Li.

5. The multilayer ceramic capacitor of claim 1, wherein:
a ratio (I_{Li}/I_{Ga}) of a signal intensity of Li to a signal intensity of Ga measured by performing transmission electron microscopy-energy dispersive X-ray spectroscopy (TEM-EDS) on the glass is 0.1 to 3.

6. The multilayer ceramic capacitor of claim 1, wherein:
the dielectric layer comprises a plurality of particles of the glass, and an average particle size of the plurality of particles is 100 nm to 500 nm.

7. The multilayer ceramic capacitor of claim 1, wherein:
the dielectric layer comprises a plurality of particles of the glass, and a maximum particle size of the plurality of particles is less than 1 μm.

8. The multilayer ceramic capacitor of claim 1, wherein:
the secondary phase is derived from a complex compound including Ga and Li.

9. The multilayer ceramic capacitor of claim 1, wherein:
the dielectric layer further comprises a barium titanate-based primary component.

10. The multilayer ceramic capacitor of claim 9, wherein:
the glass is provided as a secondary component of the dielectric layer.

11. A method for manufacturing a multilayer ceramic capacitor comprising:
mixing a secondary component comprising a complex compound including Ga and Li and a barium titanate-based primary component powder to manufacture a dielectric slurry;
manufacturing a dielectric green sheet using the dielectric slurry, and forming a conductive paste layer on the dielectric green sheet;
stacking the dielectric green sheet to manufacture a dielectric green sheet laminate;
firing the dielectric green sheet laminate to manufacture a capacitor body comprising a dielectric layer and an internal electrode layer; and
forming an external electrode on the capacitor body, wherein
the dielectric layer comprises glass having a secondary phase comprising Ga and Li.

12. The method of claim 11, wherein:
the complex compound comprises a liquid phase.

13. The method of claim 11, wherein:
a molar ratio of Ga included in the complex compound is 0.1 to 9 parts by mole with respect to 100 parts by mole of the barium titanate-based primary component powder.

14. The method of claim 11, wherein:
a molar ratio (M_{Li}/M_{Ga}) of number of moles of Li included in the complex compound to number of moles of Ga included in the complex compound is 1 to 3.

15. The method of claim 11, wherein:
the secondary component further comprises at least one selected from the group consisting of an Al-containing compound, a Mg-containing compound, and a Si-containing compound.

16. A multilayer ceramic capacitor comprising:
a capacitor body comprising a dielectric layer and an internal electrode layer; and
an external electrode positioned on an outer side of the capacitor body,
wherein the dielectric layer comprises glass including Ga and Li.

17. The multilayer ceramic capacitor of claim 16, wherein:
the glass further comprises at least one auxiliary element selected from the group consisting of Al, Mg and Si.

18. The multilayer ceramic capacitor of claim 16, wherein:
a ratio (I_{Li}/I_{Ga}) of a signal intensity of Li to a signal intensity of Ga measured by performing transmission electron microscopy-energy dispersive X-ray spectroscopy (TEM-EDS) on the glass is 0.1 to 3.

19. The multilayer ceramic capacitor of claim 16, wherein:
the dielectric layer comprises a plurality particles of the glass, and an average particle size of the plurality of particles is 100 nm to 500 nm.
